(19) United States
(12) Patent Application Publication
(10) Pub. No.: US 2020/0230875 A1
(43) Pub. Date: Jul. 23, 2020

(54) SINTERED POWDER CONTAINING A NEAR-INFRARED REFLECTOR FOR PRODUCING MOULDED BODIES

(71) Applicant: BASF SE, Ludwigshafen am Rhein (DE)

(72) Inventors: Claus GABRIEL, Ludwigshafen am Rhein (DE); Thomas MEIER, Ludwigshafen am Rhein (DE); Natalie Beatrice Janine HERLE, Ludwigshafen am Rhein (DE); Leander VERBELEN, Heidelberg (DE); Kara Ann NOACK, Florham Park, NJ (US)

(21) Appl. No.: 16/652,444

(22) PCT Filed: Oct. 1, 2018
(86) PCT No.: PCT/EP2018/076684

§ 371 Date: Mar. 31, 2020

(30) Foreign Application Priority Data
Oct. 4, 2017 (EP) 17194722.9

(51) Int. Cl. B29C 64/153; B33Y 10/00; B29C 64/268; B33Y 70/00; B29B 9/12; B29C 64/314; C08L 77/02

(52) U.S. Cl. CPC B29C 64/153; B33Y 10/00; B29C 64/268; B29K 2077/00; B29B 9/12; B29C 64/314; C08L 77/02; B33Y 70/00

(57) ABSTRACT

The present invention relates to a process for producing a shaped body, wherein, in step i), a layer of a sinter powder (SP) comprising at least one near infrared reflector inter alia is provided and, in step ii), the layer provided in step i) is exposed. The present invention further relates to a process for producing a sinter powder (SP) and to the sinter powder (SP) obtainable by this process, and to the use of a near infrared reflector in a sinter powder (SP). The present invention also relates to a shaped body obtainable by the process of the invention.

The present invention relates to a process for producing a shaped body, wherein, in step i), a layer of a sinter powder (SP) comprising at least one near infrared reflector inter alia is provided and, in step ii), the layer provided in step i) is exposed. The present invention further relates to a process for producing a sinter powder (SP) and to the sinter powder (SP) obtainable by this process, and to the use of a near infrared reflector in a sinter powder (SP). The present invention also relates to a shaped body obtainable by the process of the invention.

The rapid provision of prototypes is a problem often addressed in very recent times. One process which is particularly suitable for this so-called “rapid prototyping” is selective laser sintering (SLS). This involves selectively irradiating a plastic powder in a chamber with a laser beam. The powder melts, the molten particles coalesce and resolidify. Repeated application of plastic powder and subsequent irradiation with a laser allows modeling of three-dimensional shaped bodies.

The process of selective laser sintering for producing shaped bodies from pulverulent polymers is described in detail in patent specifications U.S. Pat. No. 6,136,948 and WO 96/06881.

Selective laser sintering is frequently too time-consuming for the production of a relatively large number of shaped bodies, and so it is possible to produce relatively large volumes of shaped bodies using high-speed sintering (HSS) or “multijet fusion technology” (MJF) from HP. In high-speed sintering, by spray application of an infrared-absorbing ink onto the component cross section to be sintered, followed by exposure with an infrared source, a higher processing speed is achieved compared to selective laser sintering.

However, a disadvantage of high-speed sintering is that the powder should not sinter outside the shaped body cross section to be sintered, nor should it stick together. Therefore, it is necessary to use as low a construction space temperature as possible in the production. The effect of this is frequently that the melting of the shaped body is not good in the shaped body cross section to be sintered and/or resultant high component warpage.

There is also frequently component warpage in selective laser sintering. If further components are present in the sinter powder as well as a pure polyamide or another pure semicrystalline polymer, the sintering window of the sinter powder is frequently reduced in the selective laser sintering operation. A reduction in the sintering window frequently leads to warpage of the shaped bodies during the production by selective laser sintering. This warpage virtually rules out use or further processing of the shaped bodies. Even during the production of the shaped bodies, the warpage can be so severe that further layer application is impossible and therefore the production process has to be stopped.

It was thus an object of the present invention to provide a process for producing shaped bodies which has the aforementioned disadvantages of the processes described in the prior art only to a lesser degree, if at all. The process should additionally be performable in a simple and inexpensive manner.

This object is achieved by a process for producing a shaped body, comprising the steps of

i) providing a layer of a sinter powder (SP) comprising the following components:
(A) at least one semicrystalline polyamide,
(B) at least one amorphous polyamide,
(C) at least one near infrared reflector,

ii) exposing the layer of the sinter powder (SP) provided in step i).

It has been found that, surprisingly, in the process of the invention, it is possible to use a higher construction space temperature, especially when the process of the invention is a high-speed sintering process or a multijet fusion process, than in processes as described in the prior art. As a result, the melting of the component in the cross section to be sintered is better and warpage is distinctly reduced compared to processes as described in the prior art. Moreover, the sinter powder (SP) used in accordance with the invention has good thermooxidative stability, which results in good reusability of the sinter powder (SP), i.e. good recyclability from the construction space.

More particularly, the process of the invention is also of good suitability as a selective laser sintering process since the sinter powder (SP) used in accordance with the invention has a broad sintering window.

Furthermore, the process of the invention affords shaped bodies that have good mechanical properties, especially a high modulus and good tensile strengths.

When the at least one near infrared reflector is a color pigment or a dye, homogeneously colored shaped bodies that retain their color even when ground and/or polished after their production are also obtained.

When the at least one near infrared reflector is a black pigment, shaped bodies of particularly deep black color are obtained in the process of the invention. Deep black colors of this kind are frequently achievable only with difficulty, if at all, with sinter powders (SP) as described in the prior art.

The process of the invention is elucidated in detail hereinafter.

Step i)

In step i), a layer of the sinter powder (SP) is provided.

The layer of the sinter powder (SP) can be provided by any methods known to those skilled in the art. Typically, the layer of the sinter powder (SP) is provided in a construction space on a construction platform. The temperature of the construction space may optionally be controlled.

The construction space has, for example, a temperature of 1 to 100 K (kelvin), preferably 5 to 50 K and especially preferably 10 to 25 K below the melting point (T_{M}) of the sinter powder (SP).

The construction space has, for example, a temperature in the range from 150 to 250° C., preferably in the range from 160 to 230° C. and especially preferably in the range from 170 to 210° C.

The layer of the sinter powder (SP) can be provided by any methods known to those skilled in the art. For example, the layer of the sinter powder (SP) is provided by means of a coating bar or a roll in the thickness to be achieved in the construction space.

The thickness of the layer of the sinter powder (SP) which is provided in step i) may be as desired. For example, it is in the range from 50 to 300 μm, preferably in the range from 70 to 200 μm and especially preferably in the range from 90 to 150 μm.

Sinter Powder (SP)

According to the invention, the sinter powder (SP) comprises at least one semicrystalline polyamide as component (A), at least one amorphous polyamide as component (B), and at least one near infrared reflector as component (C).

In the context of the present invention the terms “component (A)” and “at least one semicrystalline polyamide” are used synonymously and therefore have the same meaning.

The same applies to the terms “component (B)” and “at least one amorphous polyamide”. These terms are likewise used synonymously in the context of the present invention and therefore have the same meaning.

Correspondingly, the terms “component (C)” and “at least one near infrared reflector” are also used synonymously in the context of the present invention and have the same meaning.

The sinter powder (SP) may comprise components (A), (B) and (C) in any desired amounts.

For example, the sinter powder (SP) comprises in the range from 50% to 94.95% by weight of component (A), in the range from 5% to 40% by weight of component (B) and in the range from 0.05% to 10% by weight of component (C), based in each case on the sum total of the percentages by weight of components (A), (B) and (C), preferably based on the total weight of the sinter powder (SP).

Preferably, the sinter powder (SP) comprises in the range from 60% to 94.9% by weight of component (A), in the range from 5% to 30% by weight of component (B) and in the range from 0.1% to 8% by weight of component (C), based in each case on the sum total of the percentages by weight of components (A), (B) and (C), preferably based on the total weight of the sinter powder (SP).

Most preferably, the sinter powder (SP) comprises in the range from 70% to 91.9% by weight of component (A), in the range from 8% to 25% by weight of component (B) and in the range from 0.1% to 5% by weight of component (C), based in each case on the sum total of the percentages by weight of components (A), (B) and (C), preferably based on the total weight of the sinter powder (SP).

The present invention therefore also provides a process in which the sinter powder (SP) comprises in the range from 50% to 94.95% by weight of component (A), in the range from 5% to 40% by weight of component (B) and in the range from 0.05% to 10% by weight of component (C), based in each case on the total weight of the sinter powder (SP).

The sinter powder (SP) may further comprise at least one additive. For example, the at least one additive is selected from the group consisting of antinucleating agents, stabilizers, flow aids and end group functionalizers.

An example of a suitable antinucleating agent is lithium chloride.

Suitable stabilizers are, for example, phenols, phosphites and copper stabilizers.

Suitable end group functionalizers are, for example, terephthalic acid, adipic acid and propionic acid.

Suitable flow aids are, for example, silicas or aluminas. A preferred flow aid is alumina. An example of a suitable alumina is Aeroxide® Alu C from Evonik.

For example, the sinter powder (SP) comprises in the range from 0.1% to 10% by weight of the at least one additive, preferably in the range from 0.2% to 5% by weight and especially preferably in the range from 0.3% to 2.5% by weight, based in each case on the total weight of the sinter powder (SP).

The present invention therefore also provides a process in which the sinter powder (SP) additionally comprises in the range from 0.1% to 10% by weight of at least one additive selected from the group consisting of antinucleating agents, stabilizers and end group functionalizers, based on the total weight of the sinter powder (SP).

Preferably, the sinter powder (SP) also additionally comprises at least one reinforcing agent.

For example, the sinter powder (SP) comprises in the range from 5% to 60% by weight, preferably in the range from 10% to 50% by weight and especially preferably in the range from 15% to 40% by weight of at least one reinforcing agent, based in each case on the total weight of the sinter powder (SP).

The percentages by weight of components (A), (B) and (C) and optionally of the at least one additive and the at least one reinforcing agent typically add up to 100% by weight.

In the context of the present invention, “at least one reinforcing agent” means either exactly one reinforcing agent or a mixture of two or more reinforcing agents.

In the context of the present invention, a reinforcing agent is understood to mean a material that improves the mechanical properties of shaped bodies produced by the process of the invention compared to shaped bodies that do not comprise the reinforcing agent.

Reinforcing agents as such are known to those skilled in the art. For example, the at least one reinforcing agent may be in spherical form, in platelet form or in fibrous form.

Preferably, the at least one reinforcing agent is in platelet form or in fibrous form.

A “fibrous reinforcing agent” is understood to mean a reinforcing agent in which the ratio of length of the fibrous reinforcing agent to the diameter of the fibrous reinforcing agent is in the range from 2:1 to 40:1, preferably in the range from 3:1 to 30:1 and especially preferably in the range from 5:1 to 20:1, where the length of the fibrous reinforcing agent and the diameter of the fibrous reinforcing agent are determined by microscopy by means of image evaluation on samples after ashing, with evaluation of at least 70 000 parts of the fibrous reinforcing agent after ashing.

The length of the fibrous reinforcing agent in that case is typically in the range from 5 to 1000 μm, preferably in the range from 10 to 600 μm and especially preferably in the range from 20 to 500 μm, determined by means of microscopy with image evaluation after ashing.

The diameter in that case is, for example, in the range from 1 to 30 μm, preferably in the range from 2 to 20 μm and especially preferably in the range from 5 to 15 μm, determined by means of microscopy with image evaluation after ashing.

In a further preferred embodiment, the at least one reinforcing agent is in platelet form. In the context of the present invention, “in platelet form” is understood to mean that the particles of the at least one reinforcing agent have a ratio of diameter to thickness in the range from 4:1 to 10:1, determined by means of microscopy with image evaluation after ashing.

Suitable reinforcing agents are known to those skilled in the art and are selected, for example, from the group consisting of carbon nanotubes, carbon fibers, boron fibers, glass fibers, glass beads, silica fibers, ceramic fibers, basalt fibers, aluminosilicates, aramid fibers and polyester fibers.

Preferably, the at least one reinforcing agent is selected from the group consisting of aluminosilicates, glass fibers and carbon fibers.

More preferably, the at least one reinforcing agent is selected from the group consisting of glass fibers and carbon fibers. These reinforcing agents may additionally have been aminosilane-functionalized.

Suitable silica fibers are, for example, wollastonite.

Suitable aluminosilicates are known as such to the person skilled in the art. Aluminosilicates refer to compounds comprising Al₂O₃ and SiO₂. In structural terms, a common factor among the aluminosilicates is that the silicon atoms are tetrahedrally coordinated by oxygen atoms and the aluminum atoms are octahedrally coordinated by oxygen atoms. Aluminosilicates may additionally comprise further elements.

Preferred aluminosilicates are sheet silicates. Particularly preferred aluminosilicates are calcined aluminosilicates, especially preferably calcined sheet silicates. The aluminosilicate may additionally have been aminosilane-functionalized.

If the at least one reinforcing agent is an aluminosilicate, the aluminosilicate may be used in any form. For example, it can be used in the form of the pure aluminosilicate, but it is likewise possible that the aluminosilicate is used in mineral form. Preferably, the aluminosilicate is used in mineral form. Suitable aluminosilicates are, for example, feldspars, zeolites, sodalite, sillimanite, andalusite and kaolin. Kaolin is a preferred aluminosilicate.

The present invention therefore also provides a process in which the sinter powder (SP) additionally comprises kaolin as at least one reinforcing agent.

Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

The sinter powder (SP) comprises particles. These particles have, for example, a size in the range from 10 to 250 μm, preferably in the range from 15 to 200 μm, more preferably in the range from 20 to 120 μm and especially preferably in the range from 20 to 110 μm.

The sinter powder (SP) of the invention has, for example,

a D10 in the range from 10 to 60 μm,

a D50 in the range from 25 to 90 μm and

a D90 in the range from 50 to 150 μm.

Preferably, the sinter powder (SP) of the invention has

a D10 in the range from 20 to 50 μm,

a D50 in the range from 40 to 80 μm and

a D90 in the range from 80 to 125 μm.

The present invention therefore also provides a process in which the sinter powder (SP) has

a D10 in the range from 10 to 60 μm,

a D50 in the range from 25 to 90 μm and

a D90 in the range from 50 to 150 μm.

In the context of the present invention, the “D10” is understood to mean the particle size at which 10% by volume of the particles based on the total volume of the particles are smaller than or equal to D10 and 90% by volume of the particles based on the total volume of the particles are larger than D10. By analogy, the “D50” is understood to mean the particle size at which 50% by volume of the particles based on the total volume of the particles are smaller than or equal to D50 and 50% by volume of the particles based on the total volume of the particles are larger than D50. Correspondingly, the “D90” is understood to mean the particle size at which 90% by volume of the particles based on the total volume of the particles are smaller than or equal to D90 and 10% by volume of the particles based on the total volume of the particles are larger than D90.

To determine the particle sizes, the sinter powder (SP) is suspended in a dry state using compressed air or in a solvent, for example water or ethanol, and this suspension is analyzed. The D10, D50 and D90 values are determined by laser diffraction using a Malvern Mastersizer 3000. Evaluation is by means of Fraunhofer diffraction.

The sinter powder (SP) typically has a melting temperature (T_{M}) in the range from 160 to 280° C. Preferably, the melting temperature (T_{M}) of the sinter powder (SP) is in the range from 170 to 265° C. and especially preferably in the range from 175 to 245° C.

The present invention therefore also provides a process in which the sinter powder (SP) has a melting temperature (T_{M}) in the range from 160 to 280° C.

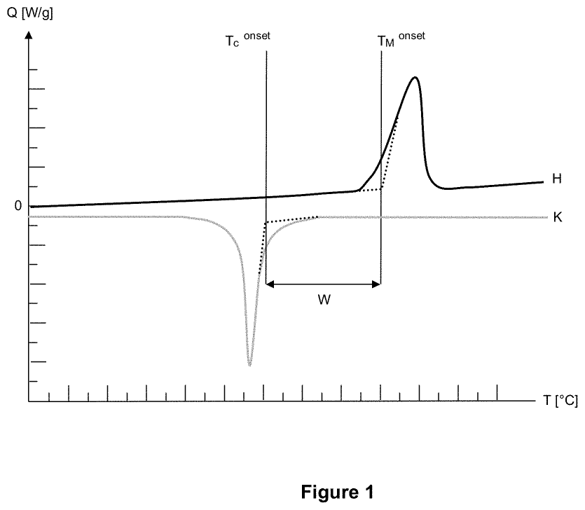

The melting temperature (T_{M}) is determined in the context of the present invention by means of differential scanning calorimetry (DSC). Typically, a heating run (H) and a cooling run (K) are measured, each at a heating rate/cooling rate of 20 K/min. This affords a DSC diagram as shown by way of example in FIG. 1. The melting temperature (T_{M}) is then understood to mean the temperature at which the melting peak of the heating run (H) of the DSC diagram has a maximum.

The sinter powder (SP) typically also has a crystallization temperature (T_{C}) in the range from 120 to 250° C. Preferably, the crystallization temperature (T_{C}) of the sinter powder (SP) is in the range from 130 to 240° C. and especially preferably in the range from 140 to 235° C.

The present invention therefore also provides a process in which the sinter powder (SP) has a crystallization temperature (T_{C}) in the range from 120 to 250° C.

The crystallization temperature (T_{C}) is determined in the context of the present invention by means of differential scanning calorimetry (DSC). This typically involves measuring a heating run (H) and a cooling run (K), each at a heating rate/cooling rate of 20 K/min. This affords a DSC diagram as shown by way of example in FIG. 1. The crystallization temperature (T_{C}) is then the temperature at the minimum of the crystallization peak of the DSC curve.

The sinter powder (SP) typically also has a sintering window (W_{SP}). The sintering window (W_{SP}) is, as described below, the difference between the onset temperature of melting (T_{M}^{onset}) and the onset temperature of crystallization (T_{C}^{onset}). The onset temperature of melting (T_{M}^{onset}) and the onset temperature of crystallization (T_{C}^{onset}) are determined as described below.

The sintering window (W_{SP}) of the sinter powder (SP) is, for example, in the range from 10 to 40 K (kelvin), more preferably in the range from 15 to 35 K and especially preferably in the range from 18 to 30 K.

The sinter powder (SP) preferably reflects radiation with a wavelength in the near infrared region. The wavelength of the near infrared region is typically in the range from 780 nm to 2.5 μm.

The sinter powder (SP) preferably reflects radiation with a wavelength in the range from 780 nm to 2.5 μm to an extent of 20% to 95%, more preferably to an extent of 25% to 93% and especially preferably to an extent of 30% to 91%.

The reflection of the sinter powder (SP) is determined with a PerkinElmer UV/VIS/NIR Lambda 950 spectrophotometer with a 150 mm Ulbricht sphere. The reference used is Spectralon white standard from Labsphere.

The sinter powder (SP) can be produced by any methods known to those skilled in the art. For example, components (A), (B) and (C) and optionally the at least one additive and the at least one reinforcing agent may be ground with one another.

The grinding can be conducted by any methods known to those skilled in the art; for example, components (A), (B) and (C) and optionally the at least one additive and the at least one reinforcing agent are introduced into a mill and ground therein.

Suitable mills include all mills known to those skilled in the art, for example classifier mills, opposed jet mills, hammer mills, ball mills, vibratory mills or rotor mills.

The grinding in the mill can likewise be effected by any methods known to those skilled in the art. For example, the grinding can take place under inert gas and/or while cooling with liquid nitrogen. Cooling with liquid nitrogen is preferred. The temperature in the grinding is as desired; preference is given to conducting the grinding at temperatures of liquid nitrogen. The temperature of the components during the grinding in that case is, for example, in the range from −40 to −30° C.

Preferably, the components are first mixed with one another and then ground. The process for producing the sinter powder (SP) in that case preferably comprises the steps of

a) mixing the following components:
(A) at least one semicrystalline polyamide,
(B) at least one amorphous polyamide,
(C) at least one near infrared reflector,
b) grinding the mixture obtained in step a) to obtain the sinter powder (SP).

The present invention therefore also provides a process for producing a sinter powder

(SP), comprising the steps of

a) mixing the following components:
(A) at least one semicrystalline polyamide,
(B) at least one amorphous polyamide,
(C) at least one near infrared reflector,

b) grinding the mixture obtained in step a) to obtain the sinter powder (SP).

In a further preferred embodiment, the process for producing the sinter powder (SP) comprises the following steps:
ai) mixing the following components:
   (A) at least one semicrystalline polyamide,
   (B) at least one amorphous polyamide,
   (C) at least one mineral flame retardant,
bi) grinding the mixture obtained in step ai) to obtain a polyamide,
bii) mixing the polyamide powder obtained in step bi) with a flow aid to obtain the sinter powder (SP).

Suitable flow aids are, for example, silicas or aluminas. A preferred flow aid is alumina. An example of a suitable alumina is Aeroxide® Alu C from Evonik.

If the sinter powder (SP) comprises a flow aid, it is preferably added in process step bii). In one embodiment, the sinter powder (SP) comprises 0.1% to 1% by weight, preferably 0.2% to 0.8% by weight and more preferably 0.3% to 0.6% by weight of flow aid, based in each case on the total weight of the sinter powder (SP) and the flow aid.

The present invention therefore also further provides a process in which step b) comprises the following steps:
bi) grinding the mixture obtained in step a) to obtain a polyamide powder,
bii) mixing the polyamide powder obtained in step bi) with a flow aid to obtain the sinter powder (SP).

Processes for compounding (for mixing) in step a) are known as such to those skilled in the art. For example, the mixing can be effected in an extruder, especially preferably in a twin-screw extruder.

The present invention therefore also provides a process for producing a sinter powder (SP), in which the components are mixed in step a) in a twin-screw extruder.

In respect of the grinding in step b), the details and preferences described above are correspondingly applicable with regard to the grinding.

The present invention therefore also further provides the sinter powder (SP) obtainable by the process of the invention.

In one embodiment of the present invention, component (C) in the sinter powder (SP) has been coated with component (A) and/or with component (B).

The present invention therefore also provides a process in which component (C) in the sinter powder (SP) has been coated with component (A) and/or with component (B).

Component (C) has typically been coated with component (A) and/or component (B) when the sinter powder (SP) has been produced by a process comprising the above-described steps a) and b), when components (A), (B) and (C) have first been compounded with one another.

In a further embodiment of the present invention, the sinter powder (SP) is in the form of a mixture. In other words, in this embodiment, component (C) is present in components (A) and (B).

Component (C) in that case is typically present alongside components (A) and (B). Component (C) is typically present alongside components (A) and (B) when the sinter powder (SP) has been produced by grinding components (A), (B) and (C) with one another without prior compounding.

The present invention therefore also provides a process in which the sinter powder (SP) is in the form of a mixture.

It will be appreciated that it is also possible for one portion of component (C) to have been coated with component (A) and/or component (B) and another portion of component (C) not to have been coated with component (A) and/or component (B).

Component (A)

According to the invention, component (A) is at least one semicrystalline polyamide.

In the context of the present invention “at least one semicrystalline polyamide” means either exactly one semicrystalline polyamide or a mixture of two or more semicrystalline polyamides.

“Semicrystalline” in the context of the present invention means that the polyamide has an enthalpy of fusion ΔH2_{(A)} of greater than 45 J/g, preferably of greater than 50 J/g and especially preferably of greater than 55 J/g, in each case measured by means of differential scanning calorimetry (DSC) according to ISO 11357-4:2014.

The at least one semicrystalline polyamide (A) of the invention thus typically has an enthalpy of fusion ΔH2_{(A)} of greater than 45 J/g, preferably of greater than 50 J/g and especially preferably of greater than 55 J/g, in each case measured by means of differential scanning calorimetry (DSC) according to ISO 11357-4:2014.

The at least one semicrystalline polyamide (A) of the invention typically has an enthalpy of fusion ΔH2_{(A)} of less than 200 J/g, preferably of less than 150 J/g and especially preferably of less than 100 J/g, in each case measured by means of differential scanning calorimetry (DSC) according to ISO 11357-4:2014.

Suitable semicrystalline polyamides (A) generally have a viscosity number (VN_{(A)}) in the range from 90 to 350 mL/g, preferably in the range from 100 to 275 mL/g and especially preferably in the range from 110 to 250 mL/g, determined in a 0.5% by weight solution of 96% by weight sulfuric acid at 25° C., measured to ISO 307:2013-8.

The present invention thus also provides a process in which component (A) has a viscosity number (VN_{(A)}) in the range from 90 to 350 mL/g, determined in a 0.5% by weight solution of component (A) in 96% by weight sulfuric acid at 25° C.

Component (A) of the invention typically has a melting temperature (T_{M(A)}). Preferably, the melting temperature (T_{M(A)}) of component (A) is in the range from 170 to 280° C., more preferably in the range from 180 to 265° C. and especially preferably in the range from 185 to 245° C., determined to ISO 11357-3:2014.

The present invention thus also provides a process in which component (A) has a melting temperature (T_{M(A)}), where the melting temperature (T_{M(A)}) is in the range from 170 to 280° C.

Suitable components (A) have a weight-average molecular weight (M_{W(A)}) in the range from 500 to 2 000 000 g/mol, preferably in the range from 10 000 to 90 000 g/mol and especially preferably in the range from 20 000 to 70 000 g/mol. The weight-average molecular weight (M_{W(A)}) is determined by means of SEC-MALLS (Size Exclusion Chromatography-Multi-Angle Laser Light Scattering) according to Chi-san Wu “Handbook of size exclusion chromatography and related techniques”, page 19.

Suitable as the at least one semicrystalline polyamide (A) are, for example, semicrystalline polyamides (A) that derive from lactams having 4 to 12 ring members. Also suitable are semicrystalline polyamides (A) that are obtained by reaction of dicarboxylic acids with diamines. Examples of at least one semicrystalline polyamide (A) that derives from lactam include polyamides that derive from polycaprolactam, polycaprylolactam and/or polylaurolactam.

If at least a semicrystalline polyamide (A) obtainable from dicarboxylic acids and diamines is used, dicarboxylic acids used may be alkanedicarboxylic acids having 6 to 12 carbon atoms. Aromatic dicarboxylic acids are also suitable.

Examples of dicarboxylic acids here include adipic acid, azelaic acid, sebacic acid and dodecanedicarboxylic acid.

Examples of suitable diamines include alkanediamines having 4 to 12 carbon atoms and aromatic or cyclic diamines, for example m-xylylenediamine, di(4-aminophenyl)methane, di(4-aminocyclohexyl)methane, 2,2-di(4-aminophenyl)propane or 2,2-di(4-aminocyclohexyl)propane.

Preferred components (A) are polycaprolactam (nylon-6) and nylon-6/6,6 copolyamide. Nylon-6/6,6 copolyamide preferably has a proportion of 5% to 95% by weight of caprolactam units, based on the total weight of the nylon-6/6,6 copolyamide.

Also suitable as at least one semicrystalline polyamide (P) are polyamides obtainable by copolymerization of two or more of the monomers mentioned above and below or mixtures of a plurality of polyamides in any desired mixing ratio. Particular preference is given to mixtures of nylon-6 with other polyamides, especially nylon-6/6,6 copolyamide.

The non-comprehensive list which follows comprises the aforementioned polyamides and further suitable semicrystalline polyamides (A), and the monomers present.

AB Polymers:

PA 4 pyrrolidone

PA 6 ε-caprolactam

PA 7 enantholactam

PA 8 caprylolactam

PA 9 9-aminopelargonic acid

P 11 11-aminoundecanoic acid

P 12 laurolactam

AA/BB Polymers:

PA 46 tetramethylenediamine, adipic acid

PA 66 hexamethylenediamine, adipic acid

PA 69 hexamethylenediamine, azelaic acid

PA 610 hexamethylenediamine, sebacic acid

PA 612 hexamethylenediamine, decanedicarboxylic acid

PA 613 hexamethylenediamine, undecanedicarboxylic acid

PA 1212 dodecane-1,12-diamine, decanedicarboxylic acid

PA 1313 tridecane-1,13-diamine, undecanedicarboxylic acid

PA 6T hexamethylenediamine, terephthalic acid

PA MXD6 m-xylylenediamine, adipic acid

PA 6/66 (see PA 6 and PA 66)

PA 6/12 (see PA 6 and PA 12)

PA 6/6,36 ε-caprolactam, hexamethylenediamine, C₃₆ dimer acid

PA 6T/6 (see PA 6T and PA 6)

Preferably, component (A) is selected from the group consisting of PA 4, PA 6, PA 7, PA 8, PA 9, PA 11, PA 12, PA 46, PA 66, PA 69, PA 6.10, PA 6.12, PA 6.13, PA6/6.36, PA 12.12, PA 13.13, PA 6T, PA 6T/6, PA MXD6, PA 6/66, PA 6/12 and copolyamides of these.

The present invention therefore also provides a process in which component (A) is selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA 12.12, PA 13.13, PA 6T, PA6T/6, PA MXD6, PA 6/66, PA 6/12 and copolyamides of these.

More preferably, component (A) is selected from the group consisting of nylon-6, nylon-6/6,6, nylon-6,10 and nylon-6,6.

Most preferably, component (A) is selected from the group consisting of nylon-6 and nylon-6/6,6.

Component (B)

Component (B) is at least one amorphous polyamide.

In the context of the present invention “at least one amorphous polyamide” means either exactly one amorphous polyamide or a mixture of two or more amorphous polyamides.

“Amorphous” in the context of the present invention means that the polyamide does not have any melting point in differential scanning calorimetry (DSC) measured according to ISO 11357.

“No melting point” means that the enthalpy of fusion of the amorphous polyamide ΔH2_{(B)} is less than 10 J/g, preferably less than 8 J/g and especially preferably less than 5 J/g, in each case measured by means of differential scanning calorimetry (DSC) according to ISO 11357-4: 2014.

The at least one amorphous polyamide (B) of the invention thus typically has an enthalpy of fusion ΔH2_{(B)} of less than 10 J/g, preferably of less than 8 J/g and especially preferably of less than 5 J/g, in each case measured by means of differential scanning calorimetry (DSC) according to ISO 11357-4:2014.

Suitable amorphous polyamides generally have a viscosity number (VN_{(B)}) in the range from 60 to 200 mL/g, preferably in the range from 70 to 150 mL/g and especially preferably in the range from 75 to 125 mL/g, determined in a 0.5% by weight solution of component (B) in 96% by weight sulfuric acid at 25° C. to ISO 307:2013-08.

Component (B) of the invention typically has a glass transition temperature (T_{G(B)}), where the glass transition temperature (T_{G(B)}) is typically in the range from 100 to 180° C., preferably in the range from 110 to 160° C. and especially preferably in the range from 120 to 155° C., determined by means of ISO 11357-2:2014.

Suitable components (B) have a weight-average molecular weight (M_{W(B)}) in the range from 5000 to 35 000 g/mol, preferably in the range from 10 000 to 30 000 g/mol and especially preferably in the range from 15 000 to 25 000 g/mol. The weight-average molecular weight is determined by means of SEC-MALLS (Size Exclusion Chromatography Multi-Angle Laser Light Scattering) according to Chi-San Wu, “Handbook of Size Exclusion Chromatography and the Related Techniques”, page 19.

Preferably, component (B) is an amorphous semiaromatic polyamide. Amorphous semiaromatic polyamides of this kind are known to those skilled in the art and are selected, for example, from the group consisting of PA 6I/6T, PA 6I and PA 6/3T.

The present invention therefore also provides a process in which component (B) is selected from the group consisting of PA 6I/6T, PA 6I and PA 6/3T.

When polyamide 6I/6T is used as component (B), this may comprise any desired proportions of 6I and 6T structural units. Preferably, the molar ratio of 6I structural units to 6T structural units is in the range from 1:1 to 3:1, more preferably in the range from 1.5:1 to 2.5:1 and especially preferably in the range from 1.8:1 to 2.3:1.

The MVR (275° C./5 kg) (melt volume flow rate) of component (B) is preferably in the range from 50 mL/10 min to 150 mL/10 min, more preferably in the range from 95 mL/10 min to 105 mL/10 min.

The zero shear rate viscosity η₀ of component (B) is, for example, in the range from 770 to 3250 Pas. Zero shear rate viscosity η₀ is determined with a “DHR-1” rotary viscometer from TA Instruments and a plate-plate geometry with a diameter of 25 mm and a plate separation of 1 mm. Unequilibrated samples of component (B) are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Component (B) has an amino end group concentration (AEG) which is preferably in the range from 30 to 45 mmol/kg and especially preferably in the range from 35 to 42 mmol/kg.

For determination of the amino end group concentration (AEG), 1 g of component (B) is dissolved in 30 mL of a phenol/methanol mixture (volume ratio of phenol:methanol 75:25) and then subjected to potentiometric titration with 0.2 N hydrochloric acid in water.

Component (B) has a carboxyl end group concentration (CEG) which is preferably in the range from 60 to 155 mmol/kg and especially preferably in the range from 80 to 135 mmol/kg.

For determination of the carboxyl end group concentration (CEG), 1 g of component (B) is dissolved in 30 mL of benzyl alcohol. This is followed by visual titration at 120° C. with 0.05 N potassium hydroxide solution in water.

Component (C)

According to the invention, component (C) is at least one near infrared reflector.

In the context of the present invention, “at least one near infrared reflector” means either exactly one near infrared reflector or a mixture of two or more near infrared reflectors.

In the context of the present invention, a near infrared reflector is understood to mean a compound that reflects radiation having a wavelength in the near infrared region.

The wavelength of the near infrared is typically in the range from 780 nm to 2.5 μm.

Component (C) reflects this radiation preferably to an extent of at least 60%, more preferably to an extent of at least 65% and especially preferably to an extent of at least 70%.

It is preferable that component (C) reflects radiation with a wavelength in the range from 780 nm to 2.5 μm to an extent of 50% to 99%, preferably to an extent of 50% to 95% and especially to an extent of 55% to 92%.

The present invention therefore also provides a process in which component (C) reflects radiation with a wavelength in the range from 780 nm to 2.5 μm to an extent of at least 60%.

The reflection is determined with a PerkinElmer UV/VIS/NIR Lambda 950 spectrophotometer with a 150 mm Ulbricht sphere. The reference used is Spectralon white standard from Labsphere.

Suitable components (C) are all near infrared reflectors known to those skilled in the art. Preference is given to near infrared-reflecting pigments. Particular preference is given to near infrared-reflecting black pigments.

It will be apparent that component (C) is different than any at least one additive present in the sinter powder (SP) and the at least one reinforcing agent.

Preferably, the sinter powder (SP) does not comprise any component that reflects radiation with a wavelength in the range from 780 nm to 2.5 μm to an extent of at least 60%, more preferably to an extent of at least 65% and especially preferably to an extent of at least 70% except for component (C).

Further preferably, the sinter powder (SP) does not comprise any component that reflects radiation with a wavelength in the range from 780 nm to 2.5 μm to an extent of 55% to 92.5%, preferably to an extent of 50% to 95% and especially preferably to an extent of 50% to 99% except for component (C).

In the context of the present invention, a near infrared-reflecting pigment is understood to mean a colorant that reflects radiation having a wavelength in the near infrared region and is insoluble in components (A) and (B).

The present invention therefore also provides a process in which component (C) is selected from the group consisting of near infrared-reflecting pigments.

Suitable near infrared-reflecting pigments are, for example, iron chromium oxides, titanium oxide, perylene dyes or aluminum pigments.

Suitable near infrared-reflecting black pigments are, for example, iron chromium oxides or perylene dyes.

Preferred near infrared reflectors are selected from the group consisting of iron chromium oxides and perylene dyes.

A preferred iron chromium oxide is obtainable, for example, under the Sicopal Black® K0095 trade name from BASF SE.

A preferred perylene dye is available, for example, under the Lumogen® Black K0087 and Lumogen® Black FK 4281 trade name from BASF SE or the Paliogen® Black S 0084 trade name from BASF SE.

A preferred titanium dioxide is available, for example, under the Kronos 2220® trade name and the Kronos 2222® trade name, each from Kronos.

A preferred aluminum pigment is available, for example, under the IReflex® 5000 White trade name from Eckart.

Component (C) is preferably not carbon black. Component (C) is further preferably not kaolin.

The present invention therefore also provides a process in which component (C) does not comprise carbon black.

The present invention also further provides a process in which component (C) does not comprise kaolin.

Step ii)

In step ii), the layer of the sinter powder (SP) provided in step i) is exposed.

On exposure, at least some of the layer of the sinter powder (SP) melts. The molten sinter powder (SP) coalesces and forms a homogeneous melt. After the exposure, the molten part of the layer of the sinter powder (SP) cools down again and the homogeneous melt solidifies again.

Suitable methods of exposure include all methods known to one skilled in the art. Preferably, the exposure in step ii) is effected with a radiation source. The radiation source is preferably selected from the group consisting of infrared sources and lasers. Especially preferred infrared sources are near infrared sources.

The present invention therefore also provides a process in which the exposing in step ii) is effected with a radiation source selected from the group consisting of lasers and infrared sources.

Suitable lasers are known to those skilled in the art and for example fiber lasers, Nd:YAG lasers (neodymium-doped yttrium aluminum garnet laser) or carbon dioxide lasers.

If the radiation source used in the exposing in step ii) is a laser, the layer of the sinter powder (SP) provided in step i) is typically exposed locally and briefly to the laser beam. This selectively melts just the parts of the sinter powder (SP) that have been exposed to the laser beam. If a laser is used in step ii), the process of the invention is also referred to as selective laser sintering. Selective laser sintering is known per se to those skilled in the art.

If the radiation source used in the exposing in step ii) is an infrared source, especially a near infrared source, the wavelength at which the radiation source radiates is typically in the range from 780 nm to 1000 μm, preferably in the range from 780 nm to 50 μm and especially in the range from 780 nm to 2.5 μm.

In the exposing in step ii), in that case, the entire layer of the sinter powder (SP) is typically exposed. In order that only the desired regions of the sinter powder (SP) melt in the exposing, an infrared-absorbing ink (IR-absorbing ink) is typically applied to the regions that are to melt.

The process for producing the shaped body in that case preferably comprises, between step i) and step ii), a step i-1) of applying at least one IR-absorbing ink to at least part of the layer of the sinter powder (SP) provided in step i).

The present invention therefore also provides a process in which the following step is conducted between step i) and step ii):
i-1) applying at least one IR-absorbing ink to at least part of the layer of the sinter powder (SP) provided in step i).

The present invention therefore also further provides a process for producing a shaped body, comprising the steps of

i) providing a layer of a sinter powder (SP) comprising the following components:
(A) at least one semicrystalline polyamide,
(B) at least one amorphous polyamide,
(C) at least one near infrared reflector,
i-1) applying at least one IR-absorbing ink to at least part of the layer of the sinter powder (SP) provided in step i),

ii) exposing the layer of the sinter powder (SP) provided in step i).

Suitable IR-absorbing inks are all IR-absorbing inks known to the person skilled in the art, especially IR-absorbing inks known to the person skilled in the art for high-speed sintering.

IR-absorbing inks typically comprise at least one absorber that absorbs IR radiation, preferably NIR radiation (near infrared radiation). In the exposing of the layer of the sinter powder (SP) in step ii), the absorption of the IR radiation, preferably the NIR radiation, by the IR absorber present in the IR-absorbing inks results in selective heating of the part of the layer of the sinter powder (SP) to which the IR-absorbing ink has been applied.

The IR-absorbing ink may, as well as the at least one absorber, comprise a carrier liquid. Suitable carrier liquids are known to those skilled in the art and are, for example, oils or solvents.

The at least one absorber may be dissolved or dispersed in the carrier liquid.

If the exposure in step ii) is effected with a radiation source selected from infrared sources and if step i-1) is conducted, the process of the invention is also referred to as high-speed sintering or multijet fusion process. These methods are known per se to the person skilled in the art.

After step ii), the layer of the sinter powder (SP) is typically lowered by the layer thickness of the layer of the sinter powder (SP) provided in step i) and a further layer of the sinter powder (SP) is applied. This is subsequently exposed again in step ii).

This firstly bonds the upper layer of the sinter powder (SP) to the lower layer of the sinter powder (SP); in addition, the particles of the sinter powder (SP) within the upper layer are bonded to one another by fusion.

In the process of the invention, steps i) and ii) and optionally i-1) can thus be repeated.

By repeating the lowering of the powder bed, the applying of the sinter powder (SP) and the exposure and hence the melting of the sinter powder (SP), three-dimensional shaped bodies are produced. It is possible to produce shaped bodies that also have cavities, for example. No additional support material is necessary since the unmolten sinter powder (SP) itself acts as a support material.

The present invention therefore also further provides a shaped body obtainable by the process of the invention.

Of particular significance in the process of the invention is the melting range of the sinter powder (SP), called the sintering window (W_{SP}) of the sinter powder (SP).

The sintering window (W_{SP}) of the sinter powder (SP) can be determined by differential scanning calorimetry (DSC) for example.

In differential scanning calorimetry, the temperature of a sample, i.e. in the present case a sample of the sinter powder (SP), and the temperature of a reference are altered linearly over time. For this purpose, heat is supplied to/removed from the sample and the reference. The amount of heat Q necessary to keep the sample at the same temperature as the reference is determined. The amount of heat OR supplied to/removed from the reference serves as a reference value.

If the sample undergoes an endothermic phase transformation, an additional amount of heat Q must be supplied to maintain the sample at the same temperature as the reference. If an exothermic phase transformation takes place, an amount of heat Q has to be removed to keep the sample at the same temperature as the reference. The measurement affords a DSC diagram in which the amount of heat Q supplied to/removed from the sample is plotted as a function of temperature T.

Measurement typically involves initially performing a heating run (H), i.e. the sample and the reference are heated in a linear manner. During the melting of the sample (solid/liquid phase transformation), an additional amount of heat Q has to be supplied to keep the sample at the same temperature as the reference. In the DSC diagram a peak known as the melting peak is then observed.

After the heating run (H), a cooling run (C) is typically measured. This involves cooling the sample and the reference linearly, i.e. heat is removed from the sample and the reference. During the crystallization/solidification of the sample (liquid/solid phase transformation), a greater amount of heat Q has to be removed to keep the sample at the same temperature as the reference, since heat is liberated in the course of crystallization/solidification. In the DSC diagram of the cooling run (C), a peak, called the crystallization peak, is then observed in the opposite direction from the melting peak.

In the context of the present invention, the heating during the heating run is typically effected at a heating rate of 20 K/min. The cooling during the cooling run in the context of the present invention is typically effected at a cooling rate of 20 K/min.

A DSC diagram comprising a heating run (H) and a cooling run (C) is depicted by way of example in FIG. 1. The DSC diagram can be used to determine the onset temperature of melting (T_{M}^{onset}) and the onset temperature of crystallization (T_{C}^{onset}).

To determine the onset temperature of melting (T_{M}^{onset}), a tangent is drawn against the baseline of the heating run (H) at the temperatures below the melting peak. A second tangent is drawn against the first point of inflection of the melting peak at temperatures below the temperature at the maximum of the melting peak. The two tangents are extrapolated until they intersect. The vertical extrapolation of the intersection to the temperature axis denotes the onset temperature of melting (T_{M}^{onset}).

To determine the onset temperature of crystallization (T_{C}^{onset}), a tangent is drawn against the baseline of the cooling run (C) at the temperatures above the crystallization peak. A second tangent is drawn against the point of inflection of the crystallization peak at temperatures above the temperature at the minimum of the crystallization peak. The two tangents are extrapolated until they intersect. The vertical extrapolation of the intersection to the temperature axis indicates the onset temperature of crystallization (T_{C}^{onset}).

The sintering window (W) results from the difference between the onset temperature of melting (T_{M}^{onset}) and the onset temperature of crystallization (T_{C}^{onset}). Thus:

W=T_{M}^{onset}−T_{M}^{onset}

In the context of the present invention, the terms “sintering window (W_{SP})”, “size of the sintering window (W_{SP})” and “difference between the onset temperature of melting (T_{M}^{onset}) and the onset temperature of crystallization (T_{C}^{onset})” have the same meaning and are used synonymously.

The sinter powder (SP) of the invention is particularly suitable for use in a sintering process.

The present invention therefore also provides for the use of a sinter powder (SP) comprising the following components:
(A) at least one semicrystalline polyamide,
(B) at least one amorphous polyamide,
(C) at least one near infrared reflector,

in a sintering process.

Shaped Body

The process of the invention affords a shaped body. The shaped body can be removed from the powder bed directly after the solidification of the sinter powder (SP) molten on exposure in step ii). It is likewise possible first to cool the shaped body and only then to remove it from the powder bed. Any adhering particles of the sinter powder that have not been melted can be mechanically removed from the surface by known methods. Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surface.

The present invention therefore further provides a shaped body obtainable by the process of the invention.

The shaped bodies obtained typically comprise in the range from 50% to 94.95% by weight of component (A), in the range from 5% to 40% by weight of component (B) and in the range from 0.05% to 10% by weight of component (C), based in each case on the total weight of the shaped body.

Preferably, the shaped body comprises in the range from 60% to 94.9% by weight of component (A), in the range from 5% to 30% by weight of component (B) and in the range from 0.1% to 8% by weight of component (C), based in each case on the total weight of the shaped body.

Most preferably, the shaped body comprises in the range from 70% to 91.9% by weight of component (A), in the range from 8% to 25% by weight of component (B) and in the range from 0.1% to 5% by weight of component (C), based in each case on the total weight of the shaped body.

According to the invention, component (A) is the component (A) that was present in the sinter powder (SP). Component (B) is likewise the component (B) that was present in the sinter powder (SP), and component (C) is likewise the component (C) that was present in the sinter powder (SP).

If the sinter powder (SP) comprises the at least one additive and/or the at least one reinforcing agent, the shaped body obtained in accordance with the invention typically also comprises the at least one additive and/or the at least one reinforcing agent.

If step i-1) has been conducted, the shaped body may additionally comprise the IR-absorbing ink.

It will be clear to the person skilled in the art that, as a result of the exposure of the sinter powder (SP), components (A), (B) and (C) and any at least one additive and the at least one reinforcing agent can enter into chemical reactions and be altered as a result. Such reactions are known to those skilled in the art.

Preferably, components (A), (B) and (C) and any at least one additive and the at least one reinforcing agent do not enter into any chemical reaction on exposure in step ii); instead, the sinter powder (SP) merely melts.

The use of the near infrared reflector (component (C)) in the sinter powder reduces warpage in the production of shaped bodies from the sinter powder (SP) via exposure of the sinter powder (SP).

The present invention therefore also provides for the use of a near infrared reflector in a sinter powder (SP) comprising the following components:
(A) at least one semicrystalline polyamide,
(B) at least one amorphous polyamide,
(C) at least one near infrared reflector,

for reducing warpage in the production of shaped bodies from the sinter powder (SP) by exposure of the sinter powder (SP).

The invention is elucidated in detail hereinafter by examples, without restricting it thereto.

### EXAMPLES

The following components are used:
semicrystalline polyamide (component (A)):
   (P1) nylon-6/6,6 (Ultramid C33, BASF SE)
amorphous polyamide (component (B)):
   (AP1) nylon-6I/6T (Grivory G16, EMS), with a molar ratio of 6I:6T of 1.9:1
near infrared reflector (component(C)):
   (C1) titanium dioxide (Kronos 2220, from Kronos)
   (C2) iron chromium oxide (Sicopal Black K0095, BASF SE)
   (C3) titanium dioxide (Kronos 2222, from Kronos)
   (C4) perylene pigment (Lumogen Black FK 4281, BASF SE)
   (C5) perylene pigment (Lumogen Black K 0087, BASF SE)
   (C6) perylene pigment (Paliogen Black S 0084, BASF SE)
   (C7) aluminum pigment (IReflex 5000 White, from Eckart)
reinforcing agent:
   (VS1) kaolin (Translink 445, BASF SE)
Additive:
   (A1) phenolic antioxidant (Irganox 1098 (N,N′-hexane-1,6-diylbis(3-(3,5-di-tert-butyl-4-hydroxyphenylpropionamide))), BASF SE)
   (A2) Special black 4 (carbon black CAS No. 1333-86-4, Evonik)
   (A3) Alu C (flow aid, from Evonik) with a BET surface area of 100±15 m²/g and a pH of 4.5 to 5.5
   (A4) Irgaphos 168 (phosphitic antioxidant, from BASF)

Table 1 states the essential parameters of the semicrystalline polyamides used (component (A)), table 2 the essential parameters of the amorphous polyamides used (component (B)).

TABLE 1

| | | | | | | Zero-shear |
|---|---|---|---|---|---|---|
| | | | | | | viscosity |
| | | AEG | CEG | T_{M} | T_{G} | η₀ at 240° C. |
| | Type | [mmol/kg] | [mmol/kg] | [° C.] | [° C.] | [Pas] |
| P1 | PA 6/66 | 47 | 40 | 193.7 | 50 | 2300 |

TABLE 2

| | | | | | Zero-shear |
|---|---|---|---|---|---|
| | | | | | viscosity η₀ |
| | | AEG | CEG | T_{g}, | at 240° C. |
| | Type | [mmol/kg] | [mmol/kg] | [° C.] | [Pas] |
| AP1 | PA 6I6T | 37 | 86 | 125 | 770 |

AEG indicates the amino end group concentration. This is determined by means of titration. For determination of the amino end group concentration (AEG), 1 g of the component (semicrystalline polyamide or amorphous polyamide) is dissolved in 30 mL of a phenol/methanol mixture (volume ratio of phenol:methanol 75:25) and then subjected to visual titration with 0.2 N hydrochloric acid in water.

CEG indicates the carboxyl end group concentration. This is determined by means of titration. For determination of the carboxyl end group concentration (CEG), 1 g of the component (semicrystalline polyamide or amorphous polyamide) is dissolved in 30 mL of benzyl alcohol and then subjected to visual titration at 120° C. with 0.05 N potassium hydroxide solution in water.

The melting temperature (T_{M}) of the semicrystalline polyamides and all glass transition temperatures (T_{G}) were each determined by means of differential scanning calorimetry.

For determination of the melting temperature (T_{M}), as described above, a first heating run (H1) at a heating rate of 20 K/min was measured. The melting temperature (T_{M}) then corresponded to the temperature at the maximum of the melting peak of the first heating run (H1).

For determination of the glass transition temperature (T_{G}), after the first heating run (H1), a cooling run (C) and subsequently a second heating run (H2) were measured. The cooling run was measured at a cooling rate of 20 K/min. The first heating run (H1) and the second heating run (H2) were measured at a heating rate of 20 K/min. The glass transition temperature (T_{G}) was then determined at half the step height of the second heating run (H2).

The zero shear rate viscosity η₀ was determined with a “DHR-1” rotary viscometer from TA Instruments and a plate-plate geometry with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Production of Sinter Powders in a Twin-Screw Extruder

For production of sinter powders, the components specified in table 3 were compounded in the ratio specified in table 3 in a twin-screw extruder (ZE25) at a throughput of 20 kg/h, a speed of 230 rpm, a length-to-diameter ratio of 40 and a barrel temperature of 245° C., and then processed with a liquid nitrogen-cooled pinned-disk mill to give powders (particle size distribution 10 to 100 μm).

TABLE 3

| | (P1) | (AP1) | (A1) | (VS1) | (A2) | (C1) | (C2) | (A3) |
|---|---|---|---|---|---|---|---|---|
| | [% by | [% by | [% by | [% by | [% by | [% by | [% by | [% by |
| Example | wt.] | wt.] | wt.] | wt.] | wt.] | wt.] | wt.] | wt.] |
| V1 | 55.98 | 8.77 | 0.25 | 35 | — | — | — | 0.4 |
| V2 | 55.68 | 8.77 | 0.25 | 35 | 0.3 | — | — | 0.4 |
| B3 | 55.55 | 8.7 | 0.25 | 35 | — | 0.5 | — | 0.4 |
| B4 | 55.48 | 8.77 | 0.25 | 35 | — | — | 0.5 | 0.4 |
| B5 | 85.38 | 13.37 | 0.25 | — | — | 1 | — | 0.4 |

For the powders, the melting temperature (T_{M}) was determined as described above.

The crystallization temperature (T_{C}) was determined by means of differential scanning calorimetry (DSC). For this purpose, first a heating run (H) at a heating rate of 20 K/min and then a cooling run (C) at a cooling rate of 20 K/min were measured. The crystallization temperature (T_{C}) is the temperature at the extreme of the crystallization peak.

The magnitude of the complex shear viscosity was determined by means of a plate-plate rotary rheometer at an angular frequency of 0.5 rad/s and a temperature of 240° C. A “DHR-1” rotary viscometer from TA Instruments was used, with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis time: 20 min, preheating time after sample preparation: 1.5 min.

The sintering window (W) was determined, as described above, as the difference between the onset temperature of melting (T_{M}^{onset}) and the onset temperature of crystallization (T_{C}^{onset}).

To determine the thermooxidative stability of the sinter powders, the complex shear viscosity of freshly produced sinter powders and of sinter powders after oven aging at 0.5% oxygen and 195° C. for 16 hours was determined. The ratio of viscosity after storage (after aging) to the viscosity before storage (before aging) was determined. The viscosity is measured by means of rotary rheology at a measurement frequency of 0.5 rad/s at a temperature of 240° C.

The particle size distribution, reported as the D10, D50 and D90, was determined as described above with a Malvern Mastersizer.

The calcination residue was determined gravimetrically after ashing.

The results can be seen in table 4.

TABLE 4

| | | | | | | Magnitude | Ratio of | | | |
|---|---|---|---|---|---|---|---|---|---|---|
| | Calcination | | | | Sintering | of complex | viscosity | | | |
| | residue | | | Sintering | window W | viscosity | after aging | | | |
| | of powder | Tₘ | T_{C} | window W | after | at 0.5 rad/s | to before | D10 | D50 | D90 |
| Example | [%] | [° C.] | [° C.] | [K] | aging [K] | [Pas] | aging | [μm] | [μm] | [μm] |
| V1 | 34.7 | 192.2 | 148.3 | 24.3 | 35.7 | 8039 | 1.6 | 38.13 | 64.61 | 106.98 |
| V2 | n.d.* | 192.6 | 147.3 | 25.1 | 36.1 | 12212 | 1.0 | 37.85 | 63.75 | 105.03 |
| B3 | 35.9 | 192.5 | 148 | 25.3 | 32.5 | 6115 | 0.3 | 37.65 | 63.71 | 105.30 |
| B4 | n.d.* | 192.6 | 147.7 | 25.8 | 36.5 | 9133 | 1.6 | 37.16 | 62.96 | 104.34 |
| B5 | n.d.* | 193.0 | 148.9 | 25.1 | 37.2 | 2554 | 2.3 | 39.40 | 65.97 | 108.17 |

* n.d.: not determined

For the sinter powders (SP), the reflection thereof in the near infrared wavelength range was additionally determined. The determination was effected with a PerkinElmer UV/VIS/NIR Lambda 950 spectrophotometer with a 150 mm Ulbricht sphere, reference: Spectralon white standard from Labsphere; cuvette: special fibrous material cuvette made of quartz glass (d=0.5 cm); data interval: 1.0 nm; gap width: UV/VIS (200-800 nm)=2.0 nm, NIR (810-2100 nm): servo; integration time: UV/VIS: 0.2 s, NIR: 0.2 s; gain: UV/VIS: auto, NIR: 15; measurement speed: UV/VIS/NIR: 285 nm/min, wavelength range: 300-2500 nm; gloss trap: closed.

The results can be seen in table 5.

TABLE 5

| | Average | Average | Average | Average |
|---|---|---|---|---|
| | reflection, | reflection, | reflection, | reflection, |
| | wavelength | wavelength | wavelength | wavelength |
| | range | range | range | range |
| | 400-800 nm | 200-2500 nm | 800-2500 nm | 1200-2500 nm |
| Example | [%] | [%] | [%] | [%] |
| V1 | 63.8 | 52.3 | 53.2 | 50.0 |
| V2 | 12.5 | 15.3 | 16.3 | 17.0 |
| B3 | 60.4 | 48.9 | 49.8 | 47.0 |
| B4 | 34.0 | 43.4 | 48.6 | 47.3 |
| B5 | 81.5 | 62.7 | 60.8 | 54.0 |

It is clearly apparent that the sinter powders (SP) of the invention have good reflection of the radiation in the near infrared region.

Moreover, it is possible with the sinter powder (SP) of the invention to produce black-colored shaped bodies, and the sinter powders simultaneously have high reflection in the NIR region.

Laser Sintering Experiments

The sinter powders (SP) were introduced with a layer thickness of 0.1 mm into the cavity at the temperature specified in table 6. The sinter powders were subsequently exposed to a laser with the laser power output specified in table 6 and the point spacing specified, with a speed of the laser over the sample during exposure of 15 m/sec. The point spacing is also known as laser spacing or lane spacing. Selective laser sintering typically involves scanning in stripes. The point spacing gives the distance between the centers of the stripes, i.e. between the two centers of the laser beam for two stripes.

TABLE 6

| | Tempera- | Laser power | Laser | Point |
|---|---|---|---|---|
| Example | ture [° C.] | output [W] | speed [m/s] | spacing [mm] |
| V1 | 183 | 55 | 15 | 0.18 |
| V2 | 185 | 55 | 15 | 0.15 |
| B3 | 185 | 55 | 15 | 0.18 |
| B4 | 184 | 55 | 15 | 0.18 |
| B5 | 179 | 55 | 15 | 0.18 |

Subsequently, the properties of the tensile bars (sinter bars) obtained were determined. The tensile bars (sinter bars) obtained were tested in the dry state after drying at 80° C. for 336 hours under reduced pressure. The results are shown in table 7.

Charpy specimens were also produced, which were likewise tested in dry form (to ISO 179-2/1 eU: 1997+Amd. 1: 2011 and to ISO 179-2/1 eA (F): 1997+Amd. 1: 2011).

The tensile tests were conducted to ISO 527-2: 2012.

Heat deflection temperature (HDT) was determined according to ISO 75-2: 2013, using both Method A with an edge fiber stress of 1.8 N/mm² and Method B with an edge fiber stress of 0.45 N/mm².

TABLE 7

| | | | | | | | Unnotched | Unnotched |
|---|---|---|---|---|---|---|---|---|
| | Modulus | | | | | | Charpy | Charpy |
| | of | Breaking | Elongation | Vicat | | | impact | impact |
| | elasticity | strength | at break | B50 | HDT/A | HDT/B | resistance | resistance |
| Example | [MPa] | [MPa] | [%] | [° C.] | [° C.] | [° C.] | a_cu [kJ/m²] | a_cn [kJ/m²] |
| V1 | 4726 | 73.8 | 3.91 | 184.5 | 100.3 | 178.1 | 14.3 | 2.9 |
| V2 | 4724 | 72.4 | 3.42 | | 99 | 178.6 | 13.2 | 1.7 |
| B3 | 4753 | 75.8 | 3.35 | 182.7 | 97.5 | 171.3 | 12.2 | 3.0 |
| B4 | 5069 | 77.6 | 2.94 | 186.3 | 100 | 175.3 | 12.3 | 3.0 |
| B5 | 2965 | 69.59 | 8.87 | 173.9 | 83.9 | 160.5 | 9.09 | 2.6 |

Table 8 shows the properties of the shaped bodies in the conditioned state. For conditioning, the shaped bodies, after the drying described above, were stored at 70° C. and 62% relative humidity for 336 hours.

TABLE 8

| | Modulus of | Breaking | Elongation | Fracture |
|---|---|---|---|---|
| | elasticity | strength | at break | energy |
| Example | [MPa] | [MPa] | [%] | [mJ/mm²] |
| V1 | 1402 | 37.4 | 13.02 | 189.9 |
| V2 | 1477 | 36.8 | 11.37 | 161.9 |
| B3 | 1591 | 37.6 | 9.13 | 130.5 |
| B4 | 1608 | 38.9 | 10.01 | 149 |
| B5 | 809 | 34.2 | 48.61 | 792 |

Production of Powders in a Miniextruder

For the near infrared reflectors and for component (A2) (Special black 4), reflection was determined in the near infrared wavelength range as described above.

The results are shown in table 9.

TABLE 9

| Near infrared | Average reflection in wavelength |
|---|---|
| reflector | range 780-2500 nm [%] |
| (A2) | 6.6 |
| (C2) | 73.4 |
| (C1) | 73.7 |
| (C3) | 84.3 |
| (C5) | 75.4 |
| (C6) | 81.0 |

Subsequently, for production of powders, the components specified in table 10 were compounded in the ratio specified in table 10 in a DSM 15 cm³ miniextruder (DSM-Micro15 microcompounder) at a speed of 80 rpm (revolutions per minute) at 250° C. for a mixing time of 3 min (minutes) and then ground to a particle size of <200 μm.

TABLE 10

| | | | | | | Near |
|---|---|---|---|---|---|---|
| | (P1) | (AP1) | (A1) | (RA1) | Near | infrared |
| | [% by | [% by | [% by | [% by | infrared | reflector |
| Example | wt.] | wt.] | wt.] | wt.] | reflector | [% by wt.] |
| V6 | 55.98 | 8.77 | 0.25 | 35 | — | — |
| B7 | 55.13 | 8.63 | 0.25 | 35 | (C1) | 1 |
| B8 | 54.26 | 8.49 | 0.25 | 35 | (C1) | 2 |
| B9 | 51.66 | 8.09 | 0.25 | 35 | (C1) | 5 |
| B10 | 55.13 | 8.63 | 0.25 | 35 | (C3) | 1 |
| B11 | 51.66 | 8.09 | 0.25 | 35 | (C3) | 5 |
| B12 | 55.56 | 8.69 | 0.25 | 35 | (C4) | 0.5 |
| B13 | 55.13 | 8.63 | 0.25 | 35 | (C7) | 1 |
| B14 | 51.66 | 8.09 | 0.25 | 35 | (C7) | 5 |
| B15 | 55.56 | 8.69 | 0.25 | 35 | (C5) | 0.5 |
| B16 | 55.56 | 8.69 | 0.25 | 35 | (C6) | 0.5 |

For the sinter powders (SP) obtained, reflection in the near infrared wavelength range was then determined. The determination was effected as described above.

The results can be seen in table 11.

TABLE 11

| | Average | Average | Average | Average |
|---|---|---|---|---|
| | reflection in | reflection in | reflection in | reflection in |
| | wavelength | wavelength | wavelength | wavelength |
| | range | range | range | range |
| | 400-800 nm | 200-2500 nm | 800-2500 nm | 1200-2500 nm |
| Example | [%] | [%] | [%] | [%] |
| V6 | 47.8 | 40.6 | 39.9 | 37.6 |
| B7 | 52.2 | 43.2 | 42.5 | 39.7 |
| B8 | 56.9 | 46.2 | 45.4 | 42.2 |
| B9 | 60.8 | 48.8 | 47.9 | 44.6 |
| B10 | 54.1 | 43.5 | 42.5 | 39.4 |
| B11 | 61.0 | 47.1 | 45.7 | 42.0 |
| B12 | 14.7 | 34.7 | 40.5 | 40.8 |
| B13 | 45.8 | 40.8 | 40.6 | 39.0 |
| B14 | n.d.* | n.d.* | n.d.* | n.d.* |
| B15 | 15.7 | 34.5 | 40.2 | 38.0 |
| B16 | 25.6 | 37.4 | 41.3 | 39.0 |

n.d.* not determined

It is clearly apparent that the near infrared reflectors of the invention in sinter powders (SP) achieve elevated reflection especially within the wavelength range from 800 to 2500 nm (800 nm to 2.5 μm) compared to sinter powders without a near infrared reflector (comparative example V6).

Experiments in High-Speed Sintering HSS (Multijet Fusion, HP):

For production of the sinter powders for the high-speed sintering, the components specified in table 12 were compounded in the ratios shown therein as described above before table 3 and then ground.

TABLE 12
Formulations for high-speed sintering experiments

| | (P1) | (AP1) | (A1) | (A4) | (A2) | (C1) | (C2) | (A3) |
|---|---|---|---|---|---|---|---|---|
| | [% by | [% by | [% by | [% by | [% by | [% by | [% by | [% by |
| Example | wt.] | wt.] | wt.] | wt.] | wt.] | wt.] | wt.] | wt.] |
| B17 | 85.25 | 13 | 0.5 | 0.25 | | 1 | | 0.4 |
| B18 | 85 | 13 | 0.5 | 0.25 | | | 1.25 | 0.4 |
| V19 | 85.95 | 13 | 0.5 | 0.25 | 0.3 | | | 0.4 |
| V20 | 86.25 | 13 | 0.5 | 0.25 | | | | 0.4 |

TABLE 13
Analytical data of the powders for HSS experiments

| | | | | | | Magnitude of | Ratio of | | | |
|---|---|---|---|---|---|---|---|---|---|---|
| | Calcination | | | | Sintering | complex | viscosity | | | |
| | residue | | | Sintering | window W | viscosity | after | | | |
| | of powder | Tₘ | T_{C} | window W | after | at 0.5 rad/s | aging to | D10 | D50 | D90 |
| Example | [%] | [° C.] | [° C.] | [K] | aging [K] | [Pas] | before aging | [μm] | [μm] | [μm] |
| B17 | n.d. | 193.2 | 147.4 | 25.4 | n.d. | 900 | n.d. | 41.2 | 68.5 | 111.1 |
| B18 | n.d. | 193 | 146.2 | 26.9 | n.d. | 940 | n.d. | 39.1 | 68.6 | 115.3 |
| V19 | n.d. | n.d. | n.d. | n.d. | n.d. | n.d. | n.d. | n.d. | n.d. | n.d. |

| | |
|---|---|
| V20 | No powder obtained, since not grindable |

TABLE 14
Experimental parameters of the HSS experiments

| | Temperature on | Temperature on |
|---|---|---|
| Example | component [° C.] | surrounding powder [° C.] |
| V1 | 200-210 | 180 |
| B3 | 200-210 | 180 |
| V2 | ~200 | ~200 |
| B5 | 205 | 175 |
| B17 | 205 | 175 |
| B18 | 205 | 187 |
| V19 | ~200 | ~200 |

| | |
|---|---|
| V20 | No powder obtained, since not grindable in unfilled form |

Powder V2 cannot be processed by HSS to give components since there is no significant temperature difference between the surface of the component to be sintered and the surface of the surrounding powder.

Powder B18, in spite of its black color, can be processed very efficiently with a significant temperature difference.

TABLE 15
Mechanical properties of the high-speed
test specimens after HSS experiments

| | Modulus of | Tensile | Elongation | |
|---|---|---|---|---|
| | elasticity | strength | at break | Component |
| Example | [MPa] | [MPa] | [%] | color |
| V1 | n.d. | 24 | n.d. | white/gray |
| | | | | shading |
| B3 | n.d. | n.d. | n.d. | white/gray |
| | | | | shading |
| V2 | No parts obtained since no temperature difference | | | |
| B5 | n.d. | 57 | 0.8 | white/gray |
| | | | | shading |
| B17 | n.d. | 58 | 0.8 | white/gray |
| | | | | shading |
| B18 | n.d. | 54 | n.d. | uniformly black |

| | |
|---|---|
| V19 | No parts obtained since no temperature difference |
| V20 | No powder obtained since not grindable in unfilled form |

The mechanical properties of the shaped bodies that were obtained in the HSS experiments were determined on high-speed test specimens (type 2 according to ISO 8256 or according to ISO 527-2:2012 type CW; testing speed 1 mm/min at 23° C. and 50% relative humidity; test specimens dry after 336 hours under reduced pressure at 80° C.).

1.-14. (canceled)

15. A process for producing a shaped body, comprising the steps of:
i) providing a layer of a sinter powder (SP) comprising the following components:
(A) at least one semicrystalline polyamide,
(B) at least one amorphous polyamide,
(C) at least one near infrared reflector,
ii) exposing the layer of the sinter powder (SP) provided in step i), wherein the sinter powder (SP) comprises in the range from 50% to 94.95% by weight of component (A), in the range from 5% to 40% by weight of component (B) and in the range from 0.05% to 10% by weight of component (C), based in each case on the total weight of the sinter powder (SP).

16. The process according to claim 15, wherein component (C) reflects radiation with a wavelength in the range from 780 nm to 2.5 μm to an extent of at least 60%.

17. The process according to claim 15, wherein component (C) is selected from the group consisting of near infrared-reflecting pigments.

18. The process according to claim 15, wherein the exposing in step ii) is effected with a radiation source selected from the group consisting of lasers and infrared sources.

19. The process according to claim 15, wherein component (A) is selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA 12.12, PA 13.13, PA 6T, PA6T/6, PA MXD6, PA 6/66, PA 6/12 and copolyamides of these.

20. The process according to claim 15, wherein component (B) is selected from the group consisting of PA 6I/6T, PA 6I and PA 6/3T.

21. The process according to claim 15, wherein the following step is conducted between step i) and step ii):
i-1) applying at least one IR-absorbing ink to at least part of the layer of the sinter powder (SP) provided in step i).

22. The process according to claim 15, wherein the sinter powder (SP) additionally comprises in the range from 0.1% to 10% by weight of at least one additive selected from the group consisting of antinucleating agents, stabilizers and end group functionalizers, based on the total weight of the sinter powder (SP).

23. The process according to claim 15, wherein component (C) in the sinter powder (SP) has been coated with component (A) and/or with component (B).

24. A process for producing a sinter powder (SP), comprising the steps of
a) mixing the following components:
(A) at least one semicrystalline polyamide,
(B) at least one amorphous polyamide,
(C) at least one near infrared reflector,
b) grinding the mixture obtained in step a) to obtain the sinter powder (SP), wherein the sinter powder (SP) comprises in the range from 50% to 94.95% by weight of component (A), in the range from 5% to 40% by weight of component (B) and in the range from 0.05% to 10% by weight of component (C), based in each case on the total weight of the sinter powder (SP).

25. A sinter powder (SP) obtainable by the process according to claim 24, wherein the sinter powder (SP) comprises in the range from 50% to 94.95% by weight of component (A), in the range from 5% to 40% by weight of component (B) and in the range from 0.05% to 10% by weight of component (C), based in each case on the total weight of the sinter powder (SP).

26. A process for reducing warpage in the production of shaped bodies from the sinter powder (SP) which comprises exposing the sinter powder (SP) wherein the sinter powder (SP) comprising the following components:
(A) at least one semicrystalline polyamide,
(B) at least one amorphous polyamide and
(C) at least one near infrared reflector.

27. A sintering process which comprises the step of utilizing the sinter powder (SP) as claimed in claim 25.

28. A shaped body obtainable by the process according to claim 15, wherein the sinter powder (SP) comprises in the range from 50% to 94.95% by weight of component (A), in the range from 5% to 40% by weight of component (B) and in the range from 0.05% to 10% by weight of component (C), based in each case on the total weight of the sinter powder (SP).
